(19) United States
(12) Patent Application Publication
(10) Pub. No.: US 2025/0011631 A1
(43) Pub. Date: Jan. 9, 2025

(54) SEALANT COMPOSITION AND A PROCESS FOR ITS PREPARATION

(71) Applicant: TECHNICO INDUSTRIES LIMITED, Gurgaon (IN)

(72) Inventor: Pankaj CHAUDHARY, Munderwa (IN)

(73) Assignee: TECHNICO INDUSTRIES LIMITED, Gurgaon (IN)

(21) Appl. No.: 18/710,352

(22) PCT Filed: Nov. 15, 2022
(86) PCT No.: PCT/IB2022/060975

§ 371 Date: May 15, 2024

(30) Foreign Application Priority Data
Nov. 15, 2021 (IN) 202111052320

(51) Int. Cl. C09J 131/04; B60C 19/12; C08K 3/28; C08K 5/053; C08K 7/02

(52) U.S. Cl. CPC C09J 131/04; B60C 19/122; C08K 3/28; C08K 5/053; C08K 7/02; C09J 2405/00; C09J 2409/00; C09J 2421/00; C09J 2431/00

(57) ABSTRACT

The present disclosure relates to a sealant composition and a process for its preparation. The sealant composition of the present disclosure is capable of sealing the puncture caused by a puncturing object having diameter up to 8 mm in tubular and non-tubular tyres. Further, the sealant composition of the present disclosure has no impact on the mileage of the vehicle and on the alignment of the wheel. Additionally, the sealant composition of the present disclosure has zero impact on noise, vibrations and harshness (NVH) of the vehicle during operation.

### FIELD

The present disclosure relates to a sealant composition and a process for its preparation.

### Definitions

As used in the present disclosure, the following terms are generally intended to have the meaning as set forth below, except to the extent that the context in which they are used, indicates otherwise.

Adhesive: The term “adhesive” refers to a substance that is used to bind the two substrates together.

Anti-flagging: The term “anti-flagging” refers to a substance that imparts a thixotropic rheology to the composition.

### BACKGROUND

The background information herein below relates to the present disclosure but is not necessarily prior art.

A puncture in tyre leads to a rapid loss of air pressure and cause a flat tyre. A sealant plays an important role in the immediate repair of the tyre puncture and protects it from deflating. The sealant works on the principle of binding property of selected components in a mixture which acts instantly to seal the damage.

Conventional tyre sealants use chemicals such as halogenated chemicals, ethylene glycol, hexylene glycol, and the like. These sealants are generally corrosive in nature and are hazardous to humans and the environment as well. Further, the conventional sealant increases the tyre weight, making it difficult to handle after repair and even tend to decompose in direct sunlight. In addition, after the application of the conventional sealant in the tyres of a vehicle, vibration is observed in the vehicle.

Furthermore, conventionally during the process of repair, the tyre has to be taken out and the sealant has to be sprayed by using spray gun followed by heating. The heating is done by using a hot air gun to dry the sealant making the process time consuming and burdensome. The other operational drawbacks associated with the puncture repair include a continuous leakage of the composition through repair.

Therefore, there is felt a need to provide a sealant composition that mitigates the drawbacks mentioned herein above or at least provides a useful alternative.

### Objects

Some of the objects of the present disclosure, which at least one embodiment herein satisfies, are as follows:

An object of the present disclosure is to ameliorate one or more problems of the background or to at least provide a useful alternative.

Another object of the present disclosure is to provide a sealant composition.

Still another object of the present disclosure is to provide a sealant composition that is capable of sealing the puncture caused by a puncturing object having diameter up to 8 mm in tubular and non-tubular tyres.

Yet another object of the present disclosure is to provide a sealant composition that has no impact on the mileage of the vehicle and on the alignment of the wheel.

Still another object of the present disclosure is to provide a sealant composition that has zero impact on noise, vibrations and harshness (NVH) of the vehicle during operation.

Yet another object of the present disclosure is to provide a simple, economical and environment friendly process for the preparation of a sealant composition.

Other objects and advantages of the present disclosure will be more apparent from the following description, which is not intended to limit the scope of the present disclosure.

### SUMMARY

The present disclosure relates to a sealant composition comprising at least one adhesive material, at least one anti-freezing agent, at least one fibrous material, at least one viscosity stabilizer, at least one additive and water.

The present disclosure further relates to a process for preparing a sealant composition. The process comprises mixing predetermined amounts of at least one adhesive material, at least one anti-freezing agent, at least one fibrous material, at least one viscosity stabilizer and at least one additive in a predetermined amount of water under stirring at a predetermined speed for a predetermined time period to obtain the sealant composition.

### BRIEF DESCRIPTION OF THE ACCOMPANYING DRAWING

The present disclosure will now be described with the help of the accompanying drawing, in which:

FIG. 1 illustrates a tyre which is being filled with the sealant composition of the present disclosure;

FIG. 2 illustrates a puncture/damage in the tyre;

FIG. 3 illustrates the portion of damaged tyre which is filled and sealed with the sealant composition of the present disclosure;

FIG. 4 illustrates (a) a puncturing object of 6 mm diameter; and (b) a nail of 8 mm diameter; and

FIG. 5 illustrates (a) a tyre punctured with a puncturing object of 6 mm diameter; and (b) a tyre punctured with a puncturing object of 8 mm diameter.

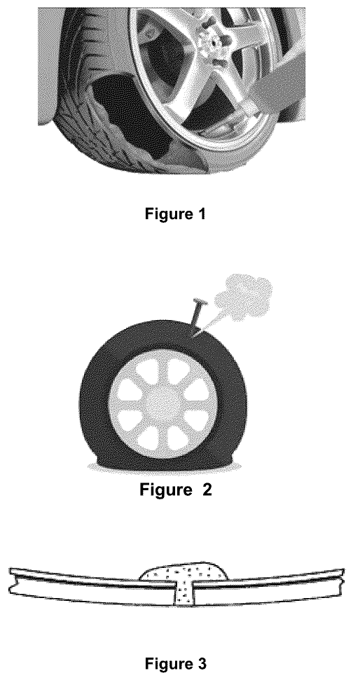

### DETAILED DESCRIPTION

The present disclosure relates to a sealant composition and a process for its preparation.

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

Conventional tyre sealants use chemicals such as halogenated chemicals, ethylene glycol, hexylene glycol, and the like. These sealants are generally corrosive in nature and are hazardous to humans and environment as well. Further, the conventional sealant increases the tyre weight, making it difficult to handle after repair and even decomposes in the direct sunlight.

Furthermore, conventionally during the process of repair, the tyre has to be taken out and the sealant has to be sprayed by using spray gun followed by heating. The heating is done by using a hot air gun to dry the sealant making the process time consuming and burdensome. The other operational drawback associated with the puncture repair is a continuous leakage of the composition through repair.

The present disclosure provides a sealant composition and a process for its preparation.

In an aspect, the present disclosure provides a sealant composition comprising:
(a) at least one adhesive material;
(b) at least one anti-freezing agent;
(c) at least one fibrous material;
(d) at least one viscosity stabilizer;
(e) at least one additive; and
(f) water.

In an embodiment of the present disclosure, the sealant composition comprises:
(a) 10 mass % to 30 mass % of said adhesive material;
(b) 15 mass % to 40 mass % of said anti-freezing agent;
(c) 0.1 mass % to 5 mass % of said fibrous material;
(d) 0.5 mass % to 15 mass % of said viscosity stabilizer;
(e) 2 mass % to 30 mass % of said additive; and
(f) 10 mass % to 35 mass % of water,
   wherein the mass % of each component is with respect to the total mass of the composition.

The adhesive material is at least one selected from montmorillonite clay, bentonite clay, mica, attapulzite clay, vinyl acetate emulsion, polyester, cyanoacrylates, vinyl acetate alcohol and polyvinyl butyral. In an exemplary embodiment of the present disclosure, the adhesive material is polyester.

The anti-freezing agent is at least one selected from the group consisting of glycerol, ethylene glycol, propylene glycol, polyethylene glycol, polypropylene glycol, diethylene glycol, calcium chloride, and sodium chloride. In an exemplary embodiment of the present disclosure, the anti-freezing agent is propylene glycol.

The fibrous material is at least one selected from the group consisting of antioxidants, staple cotton fibers, fibers of synthetic rubber and fibers of natural rubber. The natural rubber is polyisoprene. In an exemplary embodiment of the present disclosure, the fibrous material is a mixture of polyisoprene and staple cotton fibers.

Polyisoprene is the only type of natural rubber extracted from trees and also produced by polymerization of isoprene. The selected type of polyisoprene is naturally extracted, because of its better tensile strength, elongation and abrasion resistance at a working temperature in the range of −50 to 100° C., as compared to the synthetic polyisoprene rubber.

In an embodiment of the present disclosure, the fibrous material in combination with the anti-sagging agent can act as blocking agent. Preferably at least 5% of the blocking agent is formed by the rubber material.

The rubber in the blocking agent may be provided by rubber crumbs that are formed by a mixture of rubber fibres and rubber dust particles. The rubber material used in the blocking agent can conveniently be obtained from recycled rubber tyres. So when a puncture occurs, the rubber material is carried in the composition into the puncture hole being forced outwardly by tyre pressure to fill the hole within which the sealant composition sets effectively to form a permanent sealing of the puncture.

In an embodiment of the present disclosure, a dispersing agent is added in the sealant composition so that it can keep the thixotropic properties unaffected. The dispersing agent resists any tendency of the composition to clump and promotes an even dispersion of the composition on an inner surface of a tyre in use. Thus, the tyre will remain balanced during the use of the sealant composition as the sealant will spread out evenly within the tyre.

The dispersing agent can be selected from sodium carboxymethylcellulose, methylcellulose and microcrystalline cellulose.

The viscosity stabilizer is pentaerythritol tetrakis(3-(3,5-di-tert-butyl-4-hydroxyphenyl)propionate) (irganox 1010).

The additive is at least one selected from tackifier, binder, anti-decomposing element, anti-flagging agent, buffering agent, preservatives and colorants.

The tackifier is at least one selected from the group consisting of xantham gum, rosins, terpenes, terpene-phenol, phenol formaldehyde, polysaccharide and derivatives of polysaccharide. In an exemplary embodiment of the present disclosure, the tackifier is xantham gum.

Xanthan gum is a polysaccharide and acts as an effective thickening agent and stabilizer.

Combination of the tackifier and the fibrous material used in the sealant composition of the present disclosure inhibits the sealant coating from free falling due to gravitation during idle condition of the vehicle, making zero impact on NVH (noise, vibration and harshness) of vehicle during operation.

The binder is at least one selected from synthetic rubber, cotton fibres, cellulose fibres and a mixture of silica and alumina. In an exemplary embodiment of the present disclosure, the binder is synthetic rubber (liquid silicone rubber).

The anti-decomposing element is selected from zinc oxide and titanium oxide. In an exemplary embodiment of the present disclosure, the anti-decomposing element is titanium oxide.

The anti-flagging agent is chitosan.

The anti-flagging agent imparts a thixotropic rheology and prolongs the life of sealant composition during and after application by preventing the falling away from the substrate.

Chitosan is a linear polysaccharide composed of randomly distributed β-linked D-glucosamine and N-acetyl-D-glucosamine obtained from precipitation of chitin shells of shrimp and other crustaceans with sodium hydroxide and then De-acetylation of precipitated chitin by using Hydrochloric acid.

The buffering agent is di-potassium orthophosphate.

In accordance with an embodiment of the present disclosure, the sealant composition comprises a corrosion inhibitor. The corrosion inhibitor is nitratine (sodium nitrate).

Sodium nitrate is soluble in water and is a readily available source of the nitrate anion (NO₃⁻).

In accordance with an embodiment of the present disclosure, the sealant composition comprises an elastomer selected from synthetic rubber.

The sealant composition of the present disclosure is characterized by having a viscosity in the range of 3 Pa·s to 7 Pa·s. In an exemplary embodiment of the present disclosure, the viscosity of the sealant composition is 5 Pa·s.

The sealant composition of the present disclosure readily flows into any tyre puncture and provides an effective tyre seal which in turn leads to savings in fuel consumption. Further, the sealant composition of the present disclosure does not dry out or corrode the wheel rim on which a tyre is mounted. Furthermore, the sealant composition of the present disclosure is evenly dispersed on the inner surface of the tyre which ensures that wheel imbalance is avoided so there is no adverse effect on the handling performance of the vehicle. After use, it can be washed out from the tyre with water leaving no sticky residual or composition remaining inside the tyre.

The sealant composition of the present disclosure has many advantages such as:
the sealant composition works to fill the puncture/hole/damage caused by a nail or other object having diameter up to 8 mm in tubular and non-tubular tyres;
the sealant composition can be pre-filled in the tyre so that when hole/damage is caused in the tyre, the sealant composition which is pre-filled in the tyre may seal the damage instantly with insignificant loss of air pressure i.e. less than 5%;
the sealant composition is helpful in sealing and avoiding breakdown in any situation (w.r.t. climatic variation and the heat generated during operation up to about −39° C. to 120° C. temperature), in all types of tyres;
the sealant composition hinders the continuous leakage of the composition from repair plugs or linear portion of the tyre;
the sealant composition is non-corrosive, eco-friendly, cost effective, water washable;
the sealant composition will not decompose even when the vehicle is parked under the influence of the direct sunlight;
the sealant composition has no impact on the mileage of the vehicle and on the alignment of the wheel; and
the sealant composition has zero impact on noise, vibrations and harshness (NVH) of the vehicle during operation.

The sealant composition has its application in tyres of bicycles, motorbikes, cars, heavy duty transportations vehicles such as off road and on road vehicles including trucks and buses, armored vehicles, agricultural purpose vehicles, and the like.

In another aspect, the present disclosure provides a process for the preparation of the sealant composition.

The process comprises mixing predetermined amounts of at least one adhesive material, at least one anti-freezing agent, at least one fibrous material, at least one viscosity stabilizer and at least one additive in a predetermined amount of water under stirring at a predetermined speed for a predetermined time period to obtain said sealant composition.

The predetermined amounts are 20 mass % to 60 mass % of the adhesive material; 10 mass % to 30 mass % of the adhesive material; 15 mass % to 40 mass % of the anti-freezing agent; 0.1 mass % to 5 mass % of the fibrous material; 0.5 mass % to 15 mass % of the viscosity stabilizer; 2 mass % to 30 mass % of the additive; and 10 mass % to 35 mass % of water, wherein the mass % of each component is with respect to the total mass of the sealant composition.

The predetermined stirring speed is in the range of 1200 rpm to 2000 rpm. In an exemplary embodiment of the present disclosure, the predetermined speed is 1600 rpm.

The predetermined time period is in the range of 30 minutes to 60 minutes. In an exemplary embodiment of the present disclosure, the predetermined time period is 40 minutes.

The process of the present disclosure is simple, economical and environment friendly.

The foregoing description of the embodiments has been provided for purposes of illustration and not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

### Experiment 1: Process for the Preparation of the Sealant Composition in Accordance with the Present Disclosure

Examples 1 to 3: The predetermined amounts of the components as given in Table 1 were mixed under stirring at 1600 rpm for 40 minutes to obtain the sealant composition having a viscosity of 5 Pa·s.

TABLE 1
Sealant compositions in accordance with the present disclosure

| Components of the sealant composition | | Exam- | Exam- | Exam- |
|---|---|---|---|---|
| (in mass %) | | ple 1 | ple 2 | ple 3 |
| Adhesive material | Polyvinyl ester | 10 | 20 | 20 |
| Anti-freeze Agent | Propylene glycol | 30 | 30 | 25 |
| Fibrous material | Polyisoprene and | 0.5 | 1 | 2 |
| | cotton fibers | | | |
| Viscosity | Irganox 1010 | 0.1 | 0 | 0 |
| stabilizer | | | | |
| Tackifier | Xanthan gum | 5 | 1 | 1 |
| Anti-flagging | Chitosan | 5 | 1 | 1 |
| agent | | | | |
| Buffering agent | di-potassium | 1 | 1 | 1 |
| | orthophosphate | | | |
| Corrosion | Sodium nitrate | 1 | 1 | 0 |
| inhibitor | | | | |
| Elastomer | Synthetic rubber | 10 | 20 | 25 |
| DM Water | Water | 37.4 | 25 | 25 |

### Comparative Example: Commercial Sealant Composition

The commercially available sealant composition comprising ethylene glycol as an anti-freeze agent was used as comparative example. In the commercially available sealant composition there is no tackifier as well as no viscosity stabilizer used. major problem in the commercially available sealant composition is that vibration is observed in the vehicle after some time of the application of sealant and also balancing problem of the vehicle is observed.

### Experiment 3: Performance Study of the Sealant Compositions of Experiment 1

The Sealant compositions prepared in Examples 1 to 3 and comparative example were subjected to various performance tests.

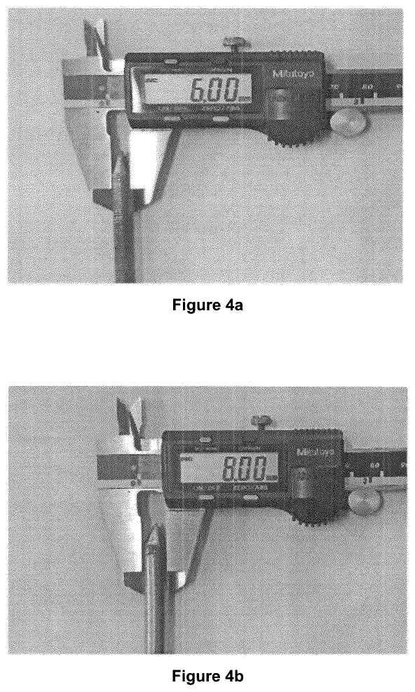

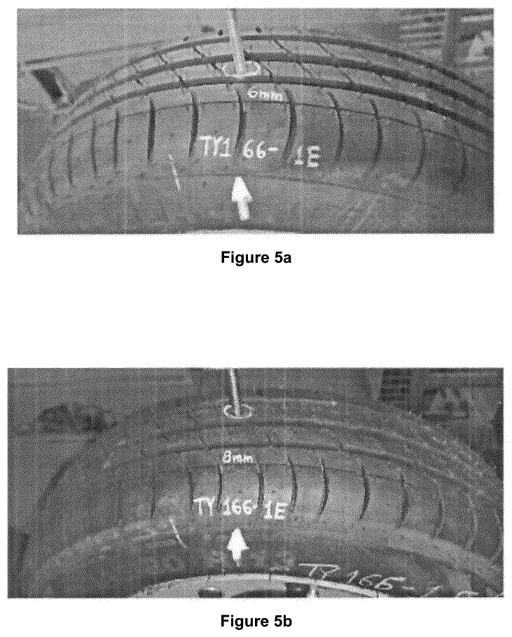

For this experiment, 145/80R13 75T tubeless Apollo Amazer 4G life car tyres were used. 200 ml of the sealant composition of example 1 was pumped into the tyres via valve housing. After closing the valve, the tyres were punctured (FIGS. 5a and 5b) at 2 locations on the thread portion by using nails of 6 mm and 8 mm diameter (FIGS. 4a and 4b). The vehicle with the punctured tyres was then taken for a short drive to circulate the sealant composition all around the tyre interior. The sealant composition of the present disclosure flows into the punctured hole under the action of the air pressure within the tyre to fill and seal the hole, thereby providing a permanent solution.

Then the punctured tyres filled with the sealant composition were subjected to various performance tests.

The above procedure was repeated for the sealant compositions of Examples 2-3 and comparative example. The tests and results are as summarized in Table 2.

TABLE 2
Performance tests of the sealant compositions

| | | Observations | | | |
|---|---|---|---|---|---|
| Sr. | | | | | Comparative |
| No. | Tests | Example 1 | Example 2 | Example 3 | Example |
| 1. | NVH Testing for | No effect | Vibration | Vibration | Vibration |
| | vehicle vibration | | | | |
| | at higher speed | | | | |
| | at 120 KMPH. | | | | |
| 2. | Rolling Resistance | No effect | No effect | Poor | Failed |
| | Test to validate | | | | |
| | impact of sealant at | | | | |
| | mileage of vehicle. | | | | |
| 3. | Endurance Test, | No effect | No effect | Poor | Failed |
| | Tyre Strength Test | | | | |
| | and Load/Speed | | | | |
| | performance test. | | | | |
| 4. | Salt spray test of | Improves | Improves | Rim | No |
| | Rim post sealant | anti- | anti- | corroded | Corrosion |
| | application, | corrosion | corrosion | | Observed |
| | | properties | properties | | |
| | | due to | due to | | |
| | | presence of | presence of | | |
| | | corrosion | corrosion | | |
| | | inhibitor | inhibitor | | |

It is observed from the Table 2 that the sealant composition of the present disclosure showed better properties as compared to the sealant composition of the comparative example. Thus, the sealant composition of the present disclosure is found to be suitable to be used in the tyres of the vehicles for sealing the puncture.

### Technical Advancements

The present disclosure described herein above has several technical advantages including, but not limited to, the realization of a sealant composition that:
is capable of sealing the puncture caused by a puncturing object having diameter up to 8 mm in tubular and non-tubular tyres;
avoids breakdown of tyres in any situation w.r.t climatic variations and heat generated during operation of up to about −39° C. to 120° C. temperature;
will not decompose even when vehicle is parked under influence of direct sunlight;
has no impact on the mileage of the vehicle and no impact on the alignment of the wheel; and
has zero impact on noise, vibrations and harshness (NVH) of the vehicle during operation.

Throughout this specification the word “comprise”, or variations such as “comprises” or “comprising”, will be understood to imply the inclusion of a stated element, integer or step,” or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A sealant composition comprising:
(a) at least one adhesive material;
(b) at least one anti-freezing agent;
(c) at least one fibrous material;
(d) at least one viscosity stabilizer;
(e) at least one additive; and
(f) water.

2. The composition as claimed in claim 1 comprises:
(a) 10 mass % to 30 mass % of said adhesive material;
(b) 15 mass % to 40 mass % of said anti-freezing agent;
(c) 0.1 mass % to 5 mass % of said fibrous material;
(d) 0.5 mass % to 15 mass % of said viscosity stabilizer;
(e) 2 mass % to 30 mass % of said additive; and
(f) 10 mass % to 35 mass % of water,
wherein the mass % of each component is with respect to the total mass of said composition.

3. The composition as claimed in claim 1, wherein said adhesive material is at least one selected from montmorillonite clay, bentonite clay, mica, attapulzite clay, vinyl acetate emulsion, polyester, cyanoacrylates, vinyl acetate alcohol and polyvinyl butyral.

4. The composition as claimed in claim 1, wherein said anti-freezing agent is at least one selected from the group consisting of glycerol, ethylene glycol, propylene glycol, polyethylene glycol, polypropylene glycol, diethylene glycol, calcium chloride and sodium chloride.

5. The composition as claimed in claim 1, wherein said fibrous material is at least one selected from the group consisting of antioxidants, staple cotton fibers, fibers of synthetic rubber and fibers of natural rubber;
wherein said natural rubber is polyisoprene.

6. The composition as claimed in claim 1, wherein said viscosity stabilizer is pentaerythritol tetrakis(3-(3,5-di-tert-butyl-4-hydroxyphenyl)propionate) (irganox 1010).

7. The composition as claimed in claim 1, wherein said additive is at least one selected from tackifier, binder, anti-decomposing element, anti-flagging agent, buffering agent and colorant.

8. The composition as claimed in claim 7, wherein said tackifier is at least one selected from the group consisting of xantham gum, rosins, terpenes, terpene-phenol, phenol formaldehyde, polysaccharide and derivatives of polysaccharide.

9. The composition as claimed in claim 7, wherein said binder is at least one selected from synthetic rubber, cotton fibres, cellulose fibres and a mixture of silica and alumina.

10. The composition as claimed in claim 7, wherein said anti-decomposing element is selected from zinc oxide and titanium oxide; said anti-flagging agent is chitosan; and said buffering agent is di-potassium orthophosphate.

11. The composition as claimed in claim 1 comprises a corrosion inhibitor and an elastomer, wherein said corrosion inhibitor is nitratine and said elastomer is synthetic rubber.

12. The composition as claimed in claim 1 is characterized by having a viscosity in the range of 3 Pa·s to 7 Pa·s.

13. A process for preparing a sealant composition, said process comprises mixing predetermined amounts of at least one adhesive material, at least one anti-freezing agent, at least one fibrous material, at least one viscosity stabilizer and at least one additive in a predetermined amount of water under stirring at a predetermined speed for a predetermined time period to obtain said sealant composition.

14. The process as claimed in claim 13, wherein said predetermined amounts are 10 mass % to 30 mass % of said adhesive material; 15 mass % to 40 mass % of said anti-freezing agent; 0.1 mass % to 5 mass % of said fibrous material; 0.5 mass % to 15 mass % of said viscosity stabilizer; 2 mass % to 30 mass % of said additive; and 10 mass % to 35 mass % of water, wherein the mass % of each component is with respect to the total mass of said sealant composition.

15. The process as claimed in claim 13, wherein said predetermined speed is in the range of 1200 rpm to 2000 rpm.

16. The process as claimed in claim 13, wherein said predetermined time period is in the range of 30 minutes to 60 minutes.
